(19) United States
(12) Patent Application Publication
(10) Pub. No.: US 2011/0258034 A1
(43) Pub. Date: Oct. 20, 2011

(54) HIERARCHICALLY-STRUCTURED INDEXING AND RETRIEVAL

(75) Inventors: Donald Metzler, Los Angeles, CA (US); Evgeniy Gabrilovich, Sunnyvale, CA (US); Vanja Josifovski, Los Gatos, CA (US); Michael Bendersky, Amherst, MA (US)

(73) Assignee: YAHOO! INC., Sunnyvale, CA (US)

(21) Appl. No.: 12/761,216

(22) Filed: Apr. 15, 2010

(51) Int. Cl. G06Q 30/00; G06F 17/30; G06Q 10/00

(52) U.S. Cl. 705/14.42; 705/14.52; 705/14.71; 707/741; 707/728; 707/E17.002; 707/E17.014

(57) ABSTRACT

Novel and efficient methods are described for indexing advertisements (“ads”) and other resources that are defined and organized in accordance with a hierarchical schema. In accordance with at least one embodiment, an ad corpus is transformed into a collection of hierarchically structured textual documents. An indexing technique that exploits the hierarchical structure is then applied to construct a compact yet effective ad index that can be used for performing advanced match or other ad retrieval functions. Various retrieval methods are also described herein that are capable of exploiting the hierarchical structure of the ad corpus to retrieve more relevant ads than those yielded by conventional methods.

### BACKGROUND OF THE INVENTION

1. Field of the Invention

The present invention generally relates to information retrieval systems. In particular, the present invention relates to information retrieval systems that index and retrieve hierarchically-defined resources.

2. Background

Textual advertisements (“ads”) are ubiquitous on the World Wide Web today, as they appear on a wide variety of Web pages ranging from obscure forums to major search engine results pages. Online textual ads connect advertisers to prospective customers, and clicks on these ads by Web users account for a significant fraction of the revenue for many online businesses: from news publishers to blogs to Web search engines. According to at least one observer, as of 2008, textual advertising comprised approximately 40% of the $22 billion online advertising market, which is predicted to double in size over the next 5 years.

Textual ads are distributed on the Web via two primary channels, namely, “sponsored search” and “content match.” In sponsored search, textual ads are shown alongside of the search results produced by a Web search engine, while in content match, contextually relevant ads are displayed within the content of generic Web pages. Historically, sponsored search evolved by allowing advertisers to explicitly bid on queries (termed “bid phrases” or “bid terms”) that they wished to display their ads for. In this paradigm, the burden of ad selection was placed primarily on the advertisers, since they needed to skillfully choose a comprehensive list of queries relevant for their ads. This scenario is called “exact match,” since the query and the bid phrase must match exactly for an ad to be shown.

However, it quickly became apparent that it is virtually impossible to explicitly enumerate billions of less popular “tail” queries and impractical to cover them via exact match, even though such queries provide valuable advertising opportunities. To unlock the revenue potential of these numerous yet individually infrequent queries, the “advanced match” method was introduced. Here, the query and the bid term no longer need to match exactly, and ads are selected algorithmically by a search engine or ad delivery system.

Recently, information retrieval techniques have been proposed for advanced match by indexing the ads as documents using the ad text visible to the user as well as the ad's bid phrases. Ads are then selected using an “ad query” that is generated from the user's query (sponsored search) or the Web page on which ads are to be displayed (content match). The ad query is executed against the index of ads using standard information retrieval matching and ranking techniques. Most implementations of advanced match make the simplifying assumption that ads are atomic units that are independent of each other, even though ads from the same advertiser could be quite similar or nearly identical.

In practice, however, textual ads are defined and organized as a hierarchically-structured database with several types of entities. In accordance with one such hierarchically-structured database, each advertiser has one or more accounts. Each account in turn contains one or more campaigns and each campaign includes one or more ad groups. Each ad group typically includes multiple creatives (i.e., the visible text of the ad) and bid phrases. Bid phrases correspond to different products or services offered by the advertiser, while creatives represent different ways to advertise those products or services. Any creative can be paired with any bid term within the same advertisement group to create an actual ad displayed to the user.

This hierarchical structure makes indexing of ads highly non-trivial, as naively indexing all possible “displayable” ads leads to a prohibitively large and ineffective index. Ad retrieval using such an index will not only be slow but will also result in suboptimal precision. There are currently no known techniques for indexing ads that exploit the hierarchical structure of the ad corpus in order to build a compact and effective index for advanced match. Additionally, there are no known ad retrieval methods that are capable of exploiting the hierarchical structure of the ad corpus to retrieve more relevant advertisements than those yielded by conventional methods.

### BRIEF SUMMARY OF THE INVENTION

Novel and efficient methods are described herein for indexing ads and other resources that are defined and organized in accordance with a hierarchical schema. In accordance with at least one embodiment, an ad corpus is transformed into a collection of hierarchically structured textual documents. An indexing technique that exploits the hierarchical structure is then applied to construct a compact yet effective ad index that can be used for performing advanced match or other ad retrieval functions. In certain embodiments in which a displayable ad comprises a combination of a creative and a bid phrase contained within a particular ad group, the indexing operation includes combining a field of text representative of a creative within an ad group with fields of text representative of all of the bid phrases within the same ad group to create a single indexing unit. In other embodiments, the indexing operation includes combining fields of text representative of all the creatives and all the bid phrases within an ad group to create a single indexing unit.

Various retrieval methods are also described herein that are capable of exploiting the hierarchical structure of the ad corpus to retrieve more relevant ads than those yielded by conventional methods. In accordance with one embodiment, the retrieval method comprises obtaining a list of the most relevant indexing units with respect to an ad query, wherein each indexing unit comprises a field of text representative of a creative contained in an ad group and fields of text representative of all the bid terms within the same ad group, extracting a ranked list of creatives there from, filtering the ranked list of creatives by ad group, and then retrieving the bid term associated with each creative on the list that is deemed most relevant to the ad query. In accordance with another embodiment, the retrieval method comprises obtaining a list of the most relevant indexing units with respect to an ad query, wherein each indexing unit comprises fields of text representative of all the creatives and bid terms contained within an ad group, retrieving the creative associated with each ad group represented in the list that is deemed most relevant to the advertisement query, and retrieving the bid term associated with each ad group represented in the list that is deemed most relevant to the ad query.

In further embodiments, the relevancy ranking obtained by using at least one of the aforementioned retrieval methods is improved by re-ranking a list of retrieved <creative, bid term> pairs based on a plurality of relevancy-related features associated with each <creative, bid term> pair and/or the ad group with which such pair is associated. Such re-ranking may comprise, for example, calculating a relevancy score for each retrieved <creative, bid term> pair that is a linear combination of weighted relevancy-related features associated with each <creative, bid term> pair and/or the ad group with which such pair is associated. The weights applied to each feature may be optimized, for example, by employing a learning to rank algorithm.

Importantly, the indexing and retrieval methods described herein in the context of an ad retrieval system can easily be extended to other information retrieval systems in which the retrievals are structured hierarchically.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example ad retrieval system in which an embodiment of the present invention may be implemented.

FIG. 2 is a block diagram of an alternate ad retrieval system in which an embodiment of the present invention may be implemented.

FIG. 3 depicts a portion of an ad database that is organized in accordance with a particular hierarchical structure.

FIG. 4 depicts a flowchart of a method for generating an index for use in ad retrieval in which each indexing unit corresponds to a single <creative, bid term> pair.

FIG. 5 depicts a flowchart of a method for retrieving ads that utilizes the index generated via the method of the flowchart of FIG. 4.

FIG. 6 depicts a flowchart of a method for generating an index for use in ad retrieval in which each indexing unit includes a field of text representative of a single creative and fields of text representative of every bid term belonging to a same ad group as the creative.

FIG. 7 depicts a flowchart of a method for retrieving ads that utilizes the index generated via the method of the flowchart of FIG. 6.

FIG. 8 depicts a flowchart of a method for generating an index for use in ad retrieval in which each indexing unit includes fields of text representative of all the creatives and all the bid terms belonging to the same ad group.

FIG. 9 depicts a flowchart of a method for retrieving ads that utilizes the index generated via the method of the flowchart of FIG. 8.

FIG. 10 depicts a graph that demonstrates the retrieval performance of a re-ranking method as measured using a normalized discounted cumulative gain (nDCG) metric.

FIG. 11 depicts a flowchart of a structured re-ranking method in accordance with an embodiment of the present invention.

FIG. 12 depicts a flowchart of a method for generating an index useable by an information retrieval system to identify resources stored in a hierarchical database in response to receiving a query.

FIG. 13 depicts a flowchart of a method for identifying one or more resources from among a plurality of resources stored in a hierarchical database in response to receiving a query.

FIG. 14 depicts a flowchart of a re-ranking method that may be performed in conjunction with the method of FIG. 13.

FIG. 15 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example Operating Environments

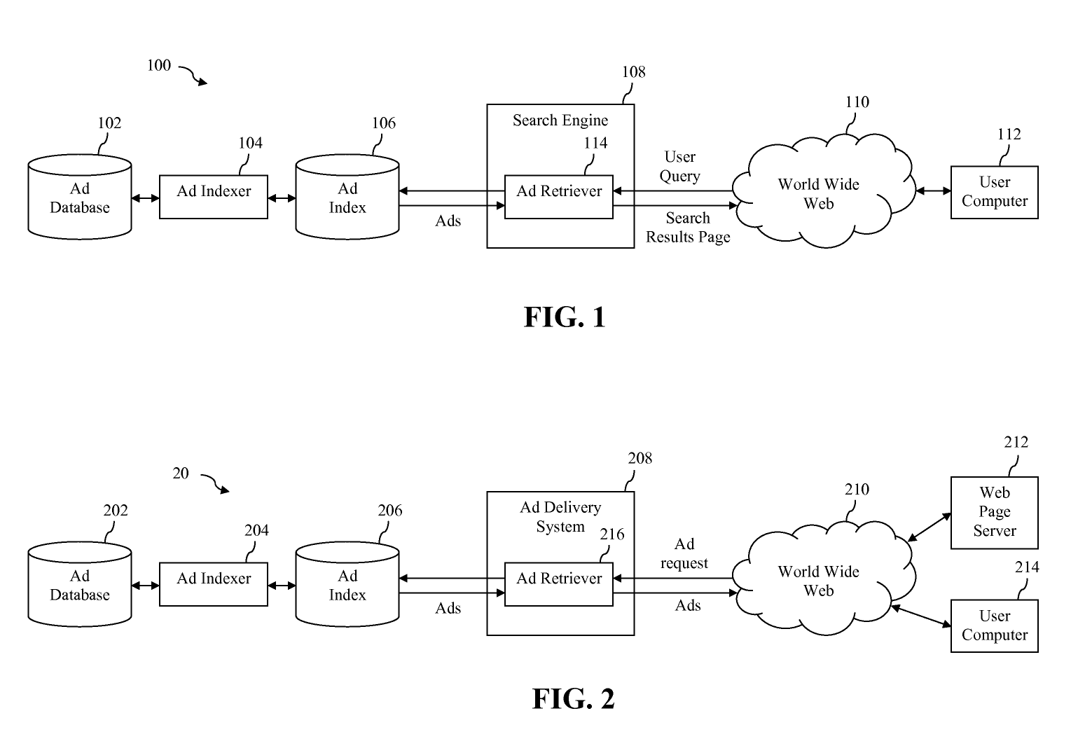

FIG. 1 is a block diagram of an example advertisement (“ad”) retrieval system 100 in which an embodiment of the present invention may be implemented. As will be discussed below, ad retrieval system 100 is a system that retrieves ads for inclusion in a search results page produced by a search engine in response to a user query. The insertion of ads into the search results page in this manner is often referred to as “sponsored search,” since an advertiser is typically required to pay for (i.e., “sponsor”) the inclusion of an ad in the search results page.

As shown in FIG. 1, system 100 includes a plurality of components including an ad database 102, an ad indexer 104, an ad index 106, a search engine 108, World Wide Web 110, and a user computer 112. Each of these components will now be described.

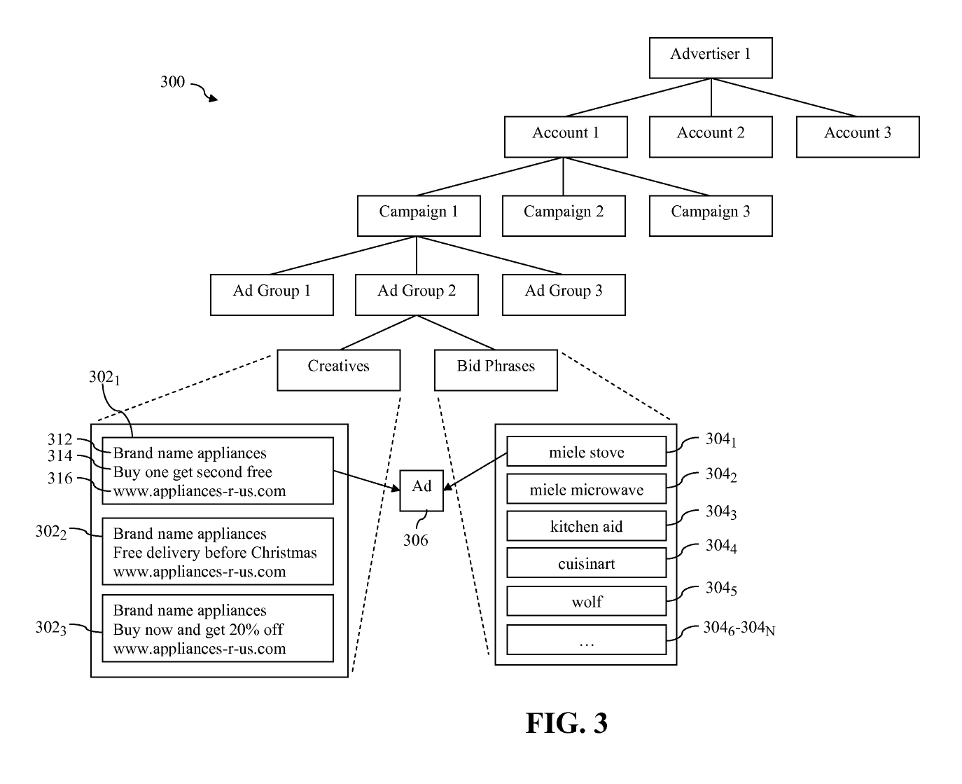

Ad database 102 comprises a hierarchically-structured database that stores textual ads. FIG. 3 depicts a portion 300 of an example implementation of ad database 102 having a particular hierarchical structure. In accordance with the exemplary hierarchical structure, an entity of the type “advertiser” is used to represent each advertiser for which ads are stored. A single example of an advertiser entity, denoted “advertiser 1,” is shown in FIG. 3. However, it is to be understood that the database may include additional advertiser entities. Each advertiser entity may contain one or more entities of the type “account.” Three examples of account entities, denoted “account 1,” “account 2” and “account 3,” are shown as being contained within advertiser entity “advertiser 1.” Each account entity may contain one or more entities of the type “ad campaigns.” In certain embodiments, each ad campaign entity corresponds to a different ad campaign having different temporal or thematic goals (e.g., sale of home appliances during the holiday season). Three examples of ad campaign entities, denoted “campaign 1,” “campaign 2” and “campaign 3,” are shown as being contained within account entity “account 1.” Campaign entities may contain one or more entities of the type “ad group.” Three examples of ad group entities, denoted “ad group 1,” “ad group 2” and “ad group 3,” are shown as being contained within campaign entity “campaign 1.” Each ad group entity may contain one or more entities of the type “creative” as well as one or more entities of the type “bid phrase.”

As used herein, the term “creative” generally refers to the visible text of an ad. Three example creatives, denoted creative 302₁, creative 302₂ and creative 302₃, are shown as being contained within ad group entity “ad group 2” in FIG. 3. As illustrated with respect to example creative 302₁, each creative includes a title 312, a description 314 and a Uniform Resource Locator (URL) 316. With continued reference to example creative 302₁, the title is “Brand name appliances,” the description is “Buy one get second free” and the URL is “www.appliances-r-us.com”. As will be appreciated by persons skilled in the relevant art(s), a creative may include text items other than or in addition to a title, description, and URL depending upon the implementation.

As used herein, a “bid phrase” generally refers to one or more terms that are associated with a product or service offered by an advertiser. Historically, the term “bid phrase” arose from sponsored search systems in which advertisers were allowed to explicitly bid on user queries that they wished to display their ads for. However, as used herein, the term “bid phrase” is not limited to phrases that are bid upon by advertisers and may encompass phrases that become associated with a product or service offered by an advertiser via other means. A plurality of example bid phrases 304₁, 304₂, 304₃, 304₄, 304₅, . . . 304_{N} are shown as being contained within ad group entity “ad group 2” in FIG. 3. As shown in FIG. 3, example bid phrase 304₁ is “miele stove,” example bid phrase 304₂ is “miele microwave,” example bid phrase 304₃ is “kitchen aid,” example bid phrase 304₄ is “cuisinart” and example bid phrase 304₅ is “wolf” In accordance with this example, each of these bid phrases is associated with brand name appliances being sold by an advertiser.

Bid phrases thus correspond to different products or services offered by an advertiser, while creatives represent different ways to advertise those products or services. In accordance with the example database implementation illustrated in FIG. 3, any creative can be paired with any bid phrase within the same ad group to create an actual ad for display to a user. For example, as shown in FIG. 3, creative 302₁ can be paired with bid phrase 304₁ to produce ad 306. Any number of creatives and bid phrases may be included within an ad group. For example, in one embodiment, a few dozen creatives and up to a thousand bid terms may be included within an ad group, thus facilitating the formation of a very large number of different creative and bid phrase pairings. This type of ad schema is designed with the needs of advertisers in mind, since it allows advertisers to easily define a large number of ads for a variety of products and marketing messages.

Ad indexer 104 comprises a system that obtains and/or generates information about each ad stored in ad database 102 and stores such information in another database, denoted ad index 106. This process may be referred to as indexing the ads stored in ad database 102. The information stored in ad index 106 is used by ad retriever 114 within search engine 108 to identify ads stored within ad database 102 that are deemed most relevant to an ad query and to rank such identified ads in order of relevancy.

As will be discussed in more detail herein, ad indexer 104 advantageously indexes the ads stored in ad database 102 in a manner that exploits the hierarchical structure associated with ad database 102. In certain embodiments, this process results in the generation of an ad index that is more compact and effective than indexes that would be generated using conventional indexing approaches. A detailed explanation of various indexing methods that may be used by ad indexer 104 will be provided herein.

Search engine 108 comprises a system that is designed to help users, such as a user of user computer 112, search for and obtain access to resources that are stored at a multitude of different interconnected nodes within World Wide Web 110. Such resources may include, for example, Web pages, text files, audio files, image files, video files, or the like. Search engine 108 may comprise, for example, a publicly-available Web search engine such Yahoo!® Search (www.yahoo.com), provided by Yahoo! Inc. of Sunnyvale, Calif., Bing™ (www.bing.com), provided by Microsoft® Corporation of Redmond, Wash., and Google™ (www.google.com), provided by Google Inc. of Mountain View, Calif.

Search engine 108 provides an interface that enables a user of user computer 112 to submit a user query that relates to one or more resources of interest. The user query may comprise, for example, a text query comprising one or more query terms. Responsive to receiving the user query, search engine 108 executes a search to identify resources on World Wide Web 110 that are deemed relevant to the user query, ranks the identified resources in accordance with a relevancy ranking scheme, and then returns a search results page to the user via user computer 112, wherein the search results page includes identified resources sorted in order of relevancy. In one embodiment, for each identified resource, the search results page includes a URL associated with the resource, a title associated with the resource, and a short summary that briefly describes the resource. The URL may be provided in the form of a link that, when activated by a user, causes user computer 112 to retrieve the associated resource from a node within World Wide Web 110.

As shown in FIG. 1, search engine 108 includes an ad retriever 114. Ad retriever 114 is configured to generate an ad query based on the user query received from user computer 112. The ad query may be identical to the user query or may be generated by refining, extending or otherwise modifying the user query to achieve improved ad retrieval performance. Ad retriever 114 then processes the information indexed in ad index 106 to select one or more ads from ad database 102 that are deemed most relevant to the ad query. This process may be referred to as executing the ad query against index 106. Ad retriever 114 also operates to rank the selected ads based on a measure of relevancy to the ad query. The ads selected and ranked by ad retriever 114 are then included within the search results page generated by search engine 108. In this way, the user of user computer 112 is provided with ads in the search results page that are relevant to the user query.

As will be discussed in more detail herein, ad retriever 114 advantageously retrieves ads in a manner that exploits the hierarchical structure associated with ad database 102. In certain embodiments, this process results in the retrieval of more relevant ads than those retrieved using conventional information retrieval techniques. A detailed explanation of various retrieval methods that may be used by ad retriever 114 will be provided herein.

User computer 112 is intended to broadly represent any system or device that is capable of interacting with a search engine, such as search engine 108. In certain embodiments, user computer 112 comprises a processor-based system or device that executes a Web browser or other software that enables a user to submit queries to and receive search results from search engine 108 via World Wide Web 110 or some other communication channel. Depending upon the implementation, such system or device may comprise, for example, a desktop computer system, a laptop computer, a tablet computer, a gaming console, a personal digital assistant, a smart telephone, a portable media player, or the like. Although only one user computer 112 is shown in FIG. 1 for the sake of simplicity, it is to be appreciated that any number of user computers, including hundreds, thousands, or even millions of user computers, may interact with search engine 108 via World Wide Web 110.

FIG. 2 is a block diagram of an alternate ad retrieval system 200 in which an embodiment of the present invention may be implemented. As will be discussed below, ad retrieval system 200 is a system that retrieves contextually-relevant advertisements for display within general Web pages delivered to users via the World Wide Web. The insertion of contextually-relevant advertisements into general Web pages in this manner is sometimes referred to as “content match,” since ads are often matched to Web pages based on Web page content.

As shown in FIG. 2, system 200 includes a plurality of components including an ad database 202, an ad indexer 204, an ad index 206, an ad delivery system 208, World Wide Web 210, a Web page server 212 and a user computer 214. Each of these components will now be described.

Ad database 202 comprises a hierarchically-structured database that stores textual ads. Ad database 202 may comprise a database having essentially the same structure as ad database 102 as described above in reference to FIG. 1 and as further described in reference to example database portion 300 of FIG. 3.

Ad indexer 204 comprises a system that obtains and/or generates information about each ad stored in ad database 202 and stores such information in another database, denoted ad index 206. Ad indexer 204 may operate in a like manner to ad indexer 104 as described above in reference to FIG. 1. For example, ad indexer 204 may index the ads stored in ad database 202 in a manner that exploits the hierarchical structure associated with ad database 202, thereby producing an ad index that is more compact and effective than indexes that would be generated using conventional indexing approaches.

Ad delivery system 208 comprises a system that is designed to provide contextually-relevant ads for insertion within generic Web pages (as opposed to search results pages) published by various entities via World Wide Web 210. Ad delivery system 208 is configured to provide such advertisements in response to ad requests received via World Wide Web 210. Depending upon the implementation, such ad requests may emanate from a Web page server 212 that is responsible for delivering a Web page to a user computer 214 or from the user computer 214. In the former case, Web page server 212 may embed the advertisements in the Web page before delivering the Web page to user computer 214. In the latter case, a Web browser executing on user computer 214 may dynamically insert the advertisements into the Web page when displaying the Web page to the user.

As shown in FIG. 2, ad delivery system 208 includes an ad retriever 216. Ad retriever 216 is configured to generate an ad query based on the content of the Web page for which ads have been requested. Ad retriever 216 then operates in a like manner to ad retriever 114 described above in reference to system 100 of FIG. 1 to process the information indexed in ad index 206 to select one or more ads from ad database 202 that are deemed most relevant to the ad query. Ad retriever 216 also operates to rank the selected ads based on a measure of relevancy to the ad query. The ads selected and ranked by ad retriever 216 are then provided to the entity requesting the ads (either Web page server 212 or user computer 214 as noted above). In this way, ad delivery system 208 provides contextually-relevant ads for insertion in Web pages.

Like ad retriever 114 discussed above in reference to FIG. 1, ad retriever 216 advantageously retrieves ads in a manner that exploits the hierarchical structure associated with ad database 202. In certain embodiments, this process results in the retrieval of more relevant ads than those retrieved using conventional information retrieval techniques.

Web page server 212 is intended to broadly represent any system or device that is capable of serving Web pages over World Wide Web 210. User computer 214 is intended to broadly represent any system or device that is capable of displaying such Web pages. For example, user computer 214 may be any of the various system or device types described above in reference to user computer 112 of FIG. 1.

The operating environments of FIGS. 1 and 2 have been described herein to facilitate a discussion of particular example implementations of the invention which will be presented below. It is to be understood that embodiments of the present invention may be implemented in operating environments other than those shown in FIGS. 1 and 2, which deal with the indexing and retrieval of textual ads. For example, embodiments of the present invention may advantageously be used to index and retrieve any of a wide variety of resources where the units to be indexed and retrieved are structured hierarchically.

### C. Example Ad Indexing and Retrieval Methods

In view of the hierarchical definition of an ad as discussed above in reference to ad databases 102 and 202, the ad retrieval problem can be formulated as the retrieval of <creative, bid phrase> pairs from a structured schema, wherein each pair comprises a displayable ad. Embodiments of the present invention arise from postulating ad retrieval as a structured retrieval problem, where the unit of retrieval is defined hierarchically. As will be discussed herein, there are several crucial tradeoffs that must be analyzed when dealing with this unique retrieval scenario.

Naïvely indexing all possible retrieval units (i.e., all possible <creative, bid phrase> combinations) using standard information retrieval indexing approaches would result in a significant amount of wasted storage, since each creative and bid phrase will be indexed multiple times due to the Cartesian product semantics. Most of the inverted indexing algorithms used in modern search engines incur increased cost with larger index sizes, making the naïve approach infeasible in practice. Hierarchically-structured indexing schemes are described herein that avoid this problem by reducing the amount of duplication. Novel ranking algorithms will also be described herein that exploit the hierarchical structure and are both more efficient and more effective than algorithms that utilize the naïve indexing approach. In one embodiment, this is achieved by employing a multi-phase retrieval approach in which an ad group is first retrieved, then an optimal creative is selected, and finally a bid phrase is chosen that makes the resulting ad the most relevant for a given query.

As noted above, a target retrieval unit in accordance with one embodiment is a <creative, bid phrase> pair, which together comprise a displayable ad. Thus, in accordance with such an embodiment, the goal of the retrieval function is to produce a ranked list of relevant <creative, bid phrase> pairs. Since the terms “bid phrase” and “bid term” are used interchangeably herein, in the following, the <creative, bid phrase> pair will be referred to as a <creative, bid term> pair.

The example indexes described herein contain two types of textual fields: creative fields (c) and bid term fields (t). In one embodiment, each creative field consists of three sub-fields: title, description and URL. This is consistent with the example creatives 302₁-302₃ described above in reference to FIG. 3. Each ad group g consists of several creative and bid term fields, grouped by an advertiser. This is also consistent with the example database structure shown in FIG. 3. The set of all ad groups is denoted G and the sets of all creatives and bid terms (for all the ad groups) are denoted C and T, respectively. The set of creatives or bid terms associated with a specific ad group g is denoted C^{g} and T^{g}, respectively. Hence, the total number of unique fields associated with a given ad corpus is:

|C|+|T|=|G|(| C̅^{g}|+| T̅^{g}|) (1)

where | C̅^{g}| and | T̅^{g}| denote the average number of creatives and bid terms per ad group, respectively.

Various retrieval methods described herein utilize a scoring function to measure the relevancy of an entity, such as an indexing unit, with respect to a query, such as an ad query. Any suitable scoring function presently known or hereinafter developed may be used to implement these methods. In certain embodiments, a scoring function associated with a well-known language modeling approach to information retrieval is utilized. In accordance with this approach, indexing units are scored by their probability of generating the query terms. Formally, given a query q and an indexing unit u, each indexing unit is scored using a unigram language model

$$p ( q \vert u ) = {\prod }_{{w}_{i} ∈ q} p ( {w}_{i} \vert u ) ,$$

where p(wᵢ|u) is estimated using Dirichlet smoothing, so that the final scoring function is as follows:

$${sc}_{q} ( u ) = {\sum }_{{w}_{i} ∈ q} log \frac{ {tf}_{{w}_{i} , u} + μ \frac{{tf}_{{w}_{i} , C}}{{\sum }_{{w}_{j} ∈ C} {tf}_{{w}_{i} , C}}}{\vert u \vert + μ} \qquad ( 2 )$$

where tf_{w,k} is the number of occurrences of a term w, in either a particular indexing unit (k=u) or the entire collection (k=C), and μ is a free parameter, which controls the amount of smoothing.

In the exemplary retrieval methods described herein, indexing units are ranked in descending order based on their score. As many ad retrieval applications require only a limited number of ads to be retrieved (e.g., a sponsored search application that returns only a limited number of ads to a user in response to her query), only a list of top K indexing units [u₍₁₎, . . . , u_{(K)}] is retrieved in accordance with these example embodiments. Furthermore, each unit u in the list is associated with an ad group identifier gIDᵤ. To promote diversity and advertiser coverage in the ranked list, certain embodiments may require that [gIDᵤ₍₁₎, . . . , gID_{u(K)}] are unique, thereby limiting the number of ads retrieved from a single ad group to one.

Three example indexing strategies and corresponding retrieval methods will now be described that may be used for performing ad retrieval. These strategies may be used, for example, to obtain a list of ads relevant to an ad query for use in applications such as sponsored search or content match. Each of the indexing methods described herein may be implemented by ad indexer 104 as described above in reference to system 100 of FIG. 1 or by ad indexer 204 as described above in reference to system 200 of FIG. 2. Each of the ad retrieval methods described herein may be implemented by ad retriever 114 as described above in reference to system 100 of FIG. 1 or by ad retriever 216 as described above in reference to system 200 of FIG. 2.

Each of the strategies presented below take into account the hierarchical structure of ad database 102 and ad database 202 as described above. The strategies are focused on the indexing of the two lower levels of the hierarchical ad structure—namely the ad group and the creative-bid term levels. The underlying principles of these strategies, however, are general enough to easily extend them to the higher levels the ad hierarchy.

As will be made clear below, each of the strategies presented differ in their choice of the atomic indexing unit and their ranking algorithms. Table 1 provides a formal definition of indexing units and estimated index sizes for each strategy. In what follows, a detailed description is provided of each indexing strategy and associated retrieval strategy.

TABLE 1
Summary of the Three Index Versions

| | | # Indexing | # Indexed |
|---|---|---|---|
| Index | Indexing Unit | Units | Fields |
| CTInd | {<c, t>: c ∈ C^{g}, | \| G ∥ T̅^{g} ∥ C̅^{g} \| | 2 \| G ∥ T̅^{g} ∥ C̅^{g} \| |
| | t ∈ T^{g}, g ∈ G} | | |
| CrtvInd | {<c, T^{g}>: c ∈ C^{g}, | \| G ∥ C̅^{g} \| | \| G ∥ C̅^{g} \| (1+ \| T̅^{g} \|) |
| | g ∈ G} | | |
| AdGrpInd | {<C^{g}, T^{g}>: g ∈ G} | \| G \| | \| C \| + \| T \| |

1. Term Coupling Based Index and Retrieval

In the first indexing scheme, each indexing units represents a <creative, bid term> pair <c,t>. This is the most fine-grained indexing unit, and this approach effectively indexes the Cartesian product of the creatives and bid terms in each ad group. The resulting index is referred to herein as CTInd. As noted above, indexing all possible <creative, bid term> pairs in each ad group can result in a prohibitively large and ineffective index and thus this approach is considered sub-optimal. However, this approach is described herein to provide a basis for comparison for other more efficient hierarchically structured ad indexing schemes.

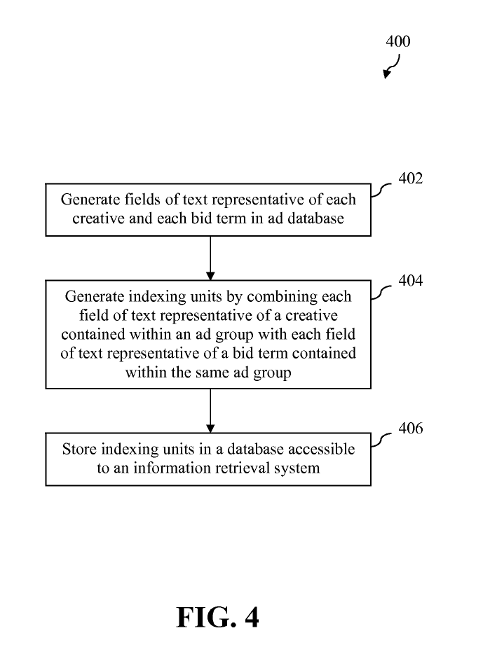

FIG. 4 depicts a flowchart 400 of a method for generating an index such as CTInd. As shown in FIG. 4, the method beings at step 402 in which fields of text are generated that are representative of each creative and each bid term that is stored in the ad database.

At step 404, indexing units are generated by combining each field of text representative of a creative contained within an ad group with each field of text representative of a bid term contained within the same ad group. This step is performed across all ad groups in the ad database. As noted above, this step effectively indexes the Cartesian product of the creatives and bid terms in each ad group.

At step 406, the indexing units are stored in a database that is accessible to an information retrieval system, such as an ad retrieval system.

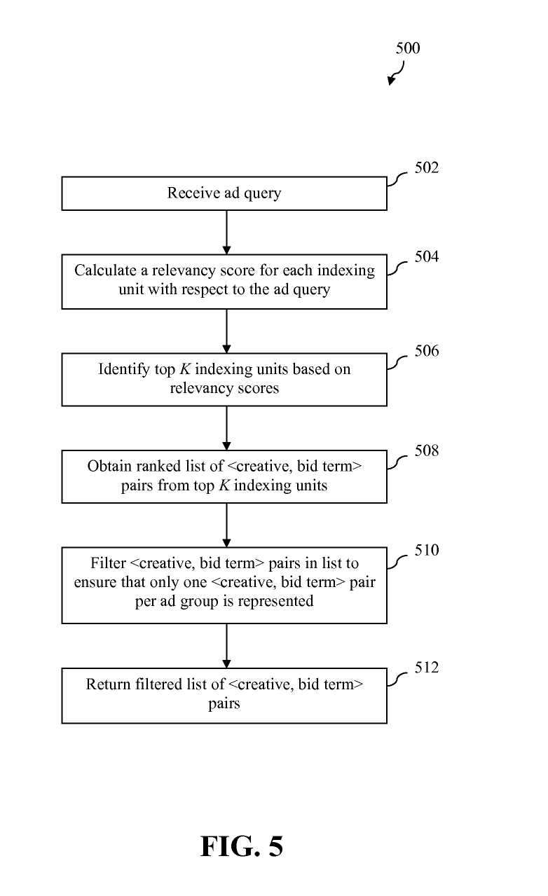

FIG. 5 depicts a flowchart 500 of a method for retrieving ads that utilizes the CTInd index generated in accordance with the method of flowchart 400. As shown in FIG. 5, the method of flowchart 500 begins at step 502 in which an ad query is received. The ad query may be received, for example and without limitation, from a search engine configured to perform sponsored search or from an ad delivery system configured to perform content match.

At step 504, a relevancy score is calculated for each indexing unit in the CTInd index with respect to the ad query. In an embodiment, the relevancy score for each indexing unit is calculated using the scoring function described above in Equation 2. However, persons skilled in the relevant art(s) will appreciate that other suitable scoring functions presently known or hereinafter developed may be used to perform this step.

At step 506, the K indexing units having the highest relevancy scores are identified and, at step 508, a ranked list of <creative, bid term> pairs is obtained from the K indexing units.

At step 510, the <creative, bid term> pairs in the ranked list are filtered to ensure that only a single <creative, bid term> pair per ad group is represented in the ranked list. This step may entail identifying <creative, bid term> pairs in the ranked list that belong to the same ad group and then removing all but the highest ranked <creative, bid term> pair in the set of identified pairs. Identifying <creative, bid term> pairs that belong to the same ad group may comprise identifying <creative, bid term> pairs that are associated with the same ad group identifier, gIDₜ.

At step 512, the filtered list of <creative, bid term> pairs produced by step 510 is returned to the entity that provided the ad query.

As demonstrated by flowchart 500, since the CTInd index is generated by indexing all possible <creative, bid term> pairs, a retrieval process that utilizes this index is essentially a single-level process. No post-processing is required, since indexing units correspond directly to displayable ads. As shall be discussed below, other more compact indexes require some additional ranking after the initial retrieval is performed. The CTInd index, on the other hand, only requires filtering by ad group to retrieve a single displayable ad per ad group. The foregoing retrieval algorithm is referred to herein as CTRank. Algorithm 1 shows the retrieval algorithm pseudocode.

Algorithm 1 CTRank (CTInd Index)

1: < c, t >← [u₍₁₎,...,u_{(K)}] [symbol] C × T
2: FILTER (c, t) BY gIDₜ
3: return < c, t >

In the CTInd index, the average number of indexing units per ad group is a product of cardinalities | C̅^{g}∥ T̅^{g}|, and each such indexing unit contains two fields (i.e., a creative and bid term field). The expected number of fields indexed by the CTInd index is, therefore, 2|G∥ T̅^{g}∥ C̅^{g}|.

2. Creative Coupling Based Index and Retrieval

In a second indexing scheme in accordance with an embodiment of the present invention, each indexing unit represents a single creative c coupled with all the bid terms associated with its ad group gID_{c}. This indexing scheme advantageously produces a much smaller index than CTInd, since it does not require computing a Cartesian product of every creative and every bid term in an ad group. This index is referred to herein as CrtvInd.

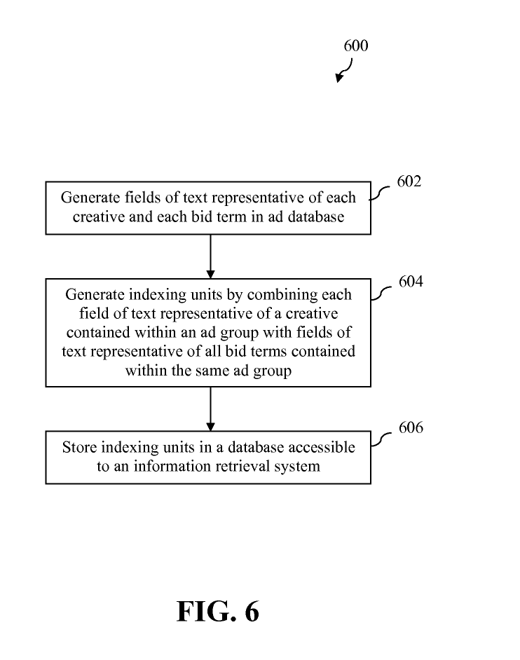

FIG. 6 depicts a flowchart 600 of a method for generating such an index. As shown in FIG. 6, the method beings at step 602 in which fields of text are generated that are representative of each creative and each bid term that is stored in the ad database.

At step 604, indexing units are generated by combining each field of text representative of a creative contained within an ad group with fields of text representative of all bid terms contained within the same ad group. This step is performed across all ad groups in the ad database. As noted above, this step results in a plurality of indexing units, wherein each indexing unit is a single creative c coupled with all the bid terms associated with its ad group gID_{c}.

At step 606, the indexing units are stored in a database that is accessible to an information retrieval system, such as an ad retrieval system.

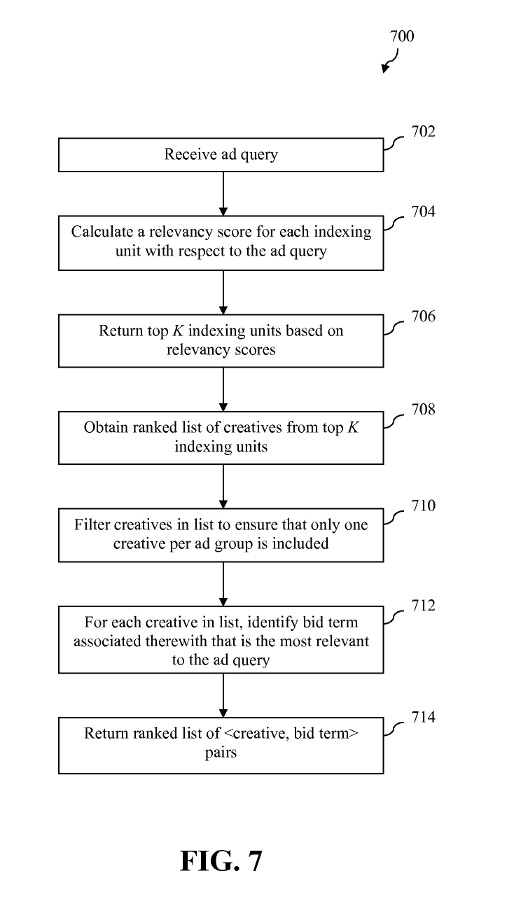

FIG. 7 depicts a flowchart 700 of a method for retrieving ads that utilizes the CrtvInd index generated in accordance with the method of flowchart 600. As shown in FIG. 7, the method of flowchart 700 begins at step 702 in which an ad query is received. The ad query may be received, for example and without limitation, from a search engine configured to perform sponsored search or from an ad delivery system configured to perform content match.

At step 704, a relevancy score is calculated for each indexing unit in the CrtvInd index with respect to the ad query. In an embodiment, the relevancy score for each indexing unit is calculated using the scoring function described above in Equation 2. However, persons skilled in the relevant art(s) will appreciate that other suitable scoring functions presently known or hereinafter developed may be used to perform this step.

At step 706, the K indexing units having the highest relevancy scores are identified and, at step 708, a ranked list of creatives is obtained from the K indexing units.

At step 710, creatives in the ranked list are filtered to ensure that only a single creative per ad group is represented in the ranked list. This step may entail identifying creatives in the ranked list that belong to the same ad group and then removing all but the highest ranked creative in the set of identified creatives. Identifying creatives that belong to the same ad group may comprise identifying creatives that are associated with the same ad group identifier, gIDₜ.

At step 712, for each creative in the filtered list, the bid term associated therewith that is the most relevant to the ad query is identified. In one embodiment, this step comprises applying the scoring function of Equation (2) to each bid term associated with each creative in the filtered list and selecting the bid term that receives the highest score for each creative. This step results in the generation of a ranked list of <creative, bid term> pairs.

At step 714, the list of <creative, bid term> pairs produced by step 712 is returned to the entity that provided the ad query.

As can be seen from the foregoing, a retrieval process that utilizes the CrtvInd index to retrieve a <creative, bid term> pair <c, t> first retrieves a ranked list of creatives, filters them by ad group, and then retrieves the bid term with the highest score associated with each creative in the list. This retrieval method is referred to herein as CrtvRank. Algorithm 2 shows the retrieval algorithm pseudocode.

Algorithm 2 CrtvRank (CrtvInd Index)

1: c ← [u₍₁₎,...,u_{(K)}] [symbol] C
2: FILTER c BY gID_{c}
3: t ← [arg max_{t∈gID}_{_{c}} sc_{q}(t) : c ∈ c]
4: return < c, t >

In the CrtvInd index, for each creative that is indexed there is, on average, 1+| T̅^{g}| fields, and there are a total of |G∥ C̅^{g}| creatives in the ad database. The expected number of indexed fields in this index is, therefore, |G∥ C̅^{g}|(1| T̅^{g}|).

3. Ad Group Coupling Based Index and Retrieval

In a third indexing scheme in accordance with an embodiment of the present invention, the indexing unit represents the ad group itself. That is to say, each indexing unit represents all of the creatives and all of the bid terms associated with a particular ad group. The index produced in accordance with this approach is referred to herein as AdGrpInd.

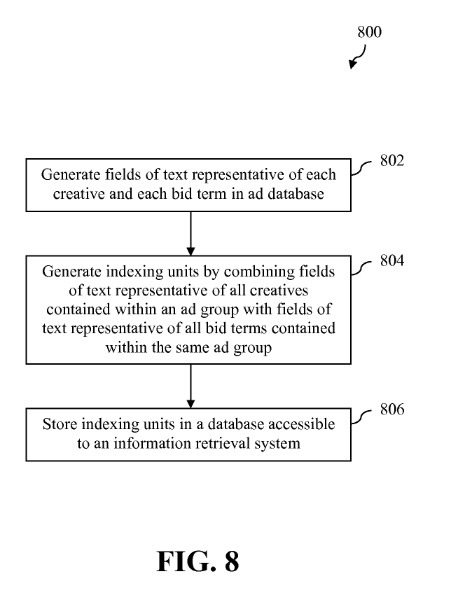

FIG. 8 depicts a flowchart 800 of a method for generating such an index. As shown in FIG. 8, the method beings at step 802 in which fields of text are generated that are representative of each creative and each bid term that is stored in the ad database.

At step 804, indexing units are generated by combining fields of text representative of all creative contained within an ad group with fields of text representative of all bid terms contained within the same ad group. This step is performed across all ad groups in the ad database. As noted above, this step results in a plurality of indexing units, wherein each indexing unit represents the ad group itself. At step 806, the indexing units are stored in a database that is accessible to an information retrieval system, such as an ad retrieval system.

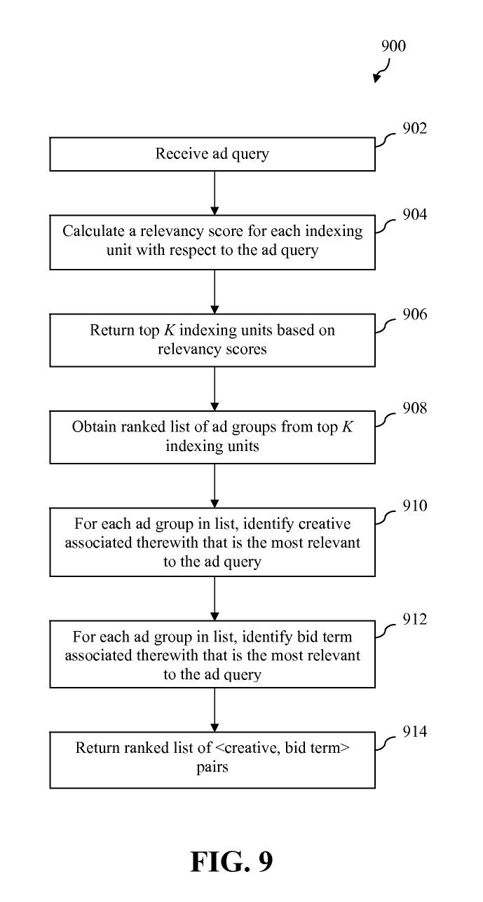

FIG. 9 depicts a flowchart 900 of a method for retrieving ads that utilizes the AdGrpInd index generated in accordance with the method of flowchart 800. As shown in FIG. 9, the method of flowchart 900 begins at step 902 in which an ad query is received. The ad query may be received, for example and without limitation, from a search engine configured to perform sponsored search or from an ad delivery system configured to perform content match.

At step 904, a relevancy score is calculated for each indexing unit in the AdGrpInd index with respect to the ad query. In an embodiment, the relevancy score for each indexing unit is calculated using the scoring function described above in Equation 2. However, persons skilled in the relevant art(s) will appreciate that other suitable scoring functions presently known or hereinafter developed may be used to perform this step.

At step 906, the K indexing units having the highest relevancy scores are identified and, at step 908, a ranked list of ad groups is obtained from the K indexing units.

At step 910, for each ad group in the list, the creative associated therewith that is the most relevant to the ad query is identified. In one embodiment, this step comprises applying the scoring function of Equation 2 to each creative associated with each ad group in the list and selecting the creative that receives the highest score for each ad group.

At step 912, for each ad group in the list, the bid term associated therewith that is the most relevant to the ad query is identified. In one embodiment, this step comprises applying the scoring function of Equation 2 to each bid term associated with each ad group in the list and selecting the bid term that receives the highest score for each ad group.

The combination of steps 910 and 912 results in the generation of a ranked list of <creative, bid term> pairs. At step 914, this ranked list of <creative, bid term> pairs is returned to the entity that provided the ad query.

Thus, in order to retrieve a <creative, bid term> pair in accordance with the foregoing method, first a ranked list of ad groups is retrieved. Then, for each ad group, a creative and a bid term with the highest relevancy scores are retrieved. Since the creative and the bid term scores are independent, and assuming that the scoring function is monotonic, the retrieved <c, t> pair is the pair with the highest score in the ad group. This retrieval algorithm is referred to herein as AdGrpRank. The algorithm pseudocode is presented in Algorithm 3.

Algorithm 3 AdGrpRank (AdGrpInd Index)

1: g ← [u₍₁₎,...,u_{(K)}] [symbol] G
2: c ← [arg max_{c∈gID}_{_{g}} sc_{q}(c) : g ∈ g]
3: t ← [arg max_{t∈gID}_{_{g}} sc_{q}(t) : g ∈ g]
4: return < g, c, t >

It is noted that the AdGrpInd index is the only index type described herein with no duplicated fields. The number of indexing units is the same as the number of ad groups, |G|, and for each ad group there are, on average, | T̅^{g}|+| C̅^{g}| fields. Therefore, the number of indexed fields is |G|(| T̅^{g}|+| C̅^{g}|), which is also the number of unique fields in the ad corpus, |C|+|T|, as shown in Equation 1.

This is the most compact index of the three alternatives described herein. Note also that this indexing scheme eliminates the need for filtering the results by the ad group identifier gIDᵤ, since by definition each retrieved ad will be constructed from a different ad group.

In view of the foregoing, it can be seen that the CrtvInd and AdGrpInd indexes, which combine like entity types having the same parent entity in the ad corpus (e.g., bid terms within the same ad group or creatives and bid terms within the same ad group), are far more compact than the CTInd index. This will advantageously result in reduced storage requirements for each index and in reduced execution time for ad retrieval processes performed using such indexes.

### D. Structured Re-Ranking

In the previous section, basic retrieval algorithms were described for each of the proposed indexing structures that ranked retrieved ads in terms of relevancy to the ad query. In some embodiments, additional steps may be performed to re-rank the retrieved ads in order to achieve improved or optimal ranking performance. It has been observed that as the size of the indexing unit grows beyond a representation of a simple <creative, bid term> pair (as is the case with the CrtvInd and AdGrp indexes described above), certain challenges present themselves that may hinder the performance of the aforementioned retrieval methods. The re-ranking methods described in this section are intended to address those challenges.

In the indexing strategies described in the preceding section, the indexed and retrieved units are hierarchically structured from atomic and composite fields. Previous work on structured document retrieval shows that a combination of field scores often yields better retrieval performance than matching each field independently.

To test this hypothesis, a simple experiment was designed that combined the scores obtained for the ad group and the <creative, bid term> pair retrieved by AdGrpRank (Algorithm 3). Formally, ads were re-ranked based on a mixture of scores:

sc_{q}(g,c,t)=λsc_{q}(u_{c,t})+(1−λ)sc_{q}(g) (3)

where u_{c,t} is a <creative, bid term> pair <c, t> treated as a single indexing unit, and sc_{q}(•) is as defined in Equation 2.

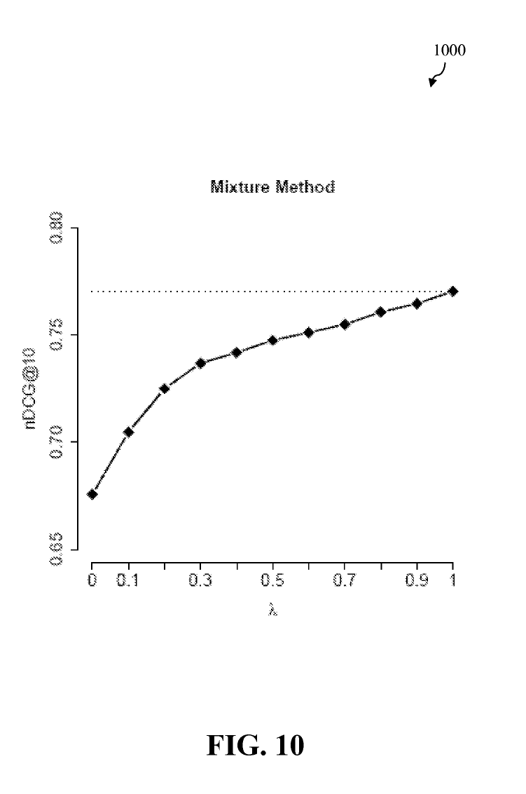

FIG. 10 depicts a graph 1000 that demonstrates the retrieval performance of this re-ranking as measured using a normalized discounted cumulative gain (nDCG) metric. In graph 1000, the solid line indicates the retrieval performance of the re-ranking while the dotted line indicates the retrieval performance obtained by CTRank with no mixture. Setting λ=0 in Equation 3 produces a ranking that is equivalent to that of AdGrpRank, while setting λ=1 produces a ranking that ignores the ad group structure, and is, therefore, equivalent to that of CTRank.

It should be noted that in contrast to previous work, where mixture models usually yield improvements, combining the <creative, bid term> pair score with the ad group score is detrimental—setting λ=1, and ignoring the ad group structure, yields the best performance. It is postulated that this is a result of several key traits that differentiate ad retrieval applications such as sponsored search from other information retrieval tasks.

For example, sponsored search is characterized by a large variance in ad group lengths. While some ad groups contain only a few bid terms, others can have up to 1,000 bid terms associated with them. This causes a strong length bias: the probability of shorter documents (ad groups with a smaller number of terms) to be retrieved is higher than their probability of being relevant. While length bias is a well-known phenomenon in information retrieval, its effects are more pronounced in sponsored search, since the latter has a much higher variance of document lengths.

Another issue that is unique for sponsored search is the cohesiveness of the ad groups. In traditional retrieval, it is usually assumed that documents, even structured ones, are about a single topic; however, this assumption does not necessarily hold for ad groups. A set of bid terms associated with an ad group can range from being focused and cohesive (associated with a single service or product) to being fragmented or even scattered (associated with several products or even with a broad set of generic bid terms), depending on the strategy of the advertiser. There is also a possibility that some advertisers might misuse the bidding mechanisms by purposefully associating unrelated bid terms to their ad groups in an attempt to attract more customers.

Since existing structured retrieval techniques do not address these issues, a novel structured re-ranking approach is described herein that is specifically tailored towards ad retrieval applications such as sponsored search. The approach relies on the ad structure and employs features that go beyond the simple mixture model in Equation 3.

In one embodiment, the structured re-ranking method is a generalization of the mixture model presented in the previous section. It takes into account a given <creative, bid term> pair and the associated ad group. The method may be applied, for example, after performing an initial retrieval round using AdGrpRank (although other retrieval methods such CrtvRank may be used). Then, the method re-ranks the initially retrieved ads using a linear model

$${rSc}_{q} ( g , c , t ) = {\sum }_{i = 1}^{n} {λ}_{i} {f}_{i} ( g , c , t ) , \qquad ( 4 )$$

where fᵢ(•) is a feature function, λᵢ are weights assigned to each function, and n is the number of such functions used for the re-ranking.

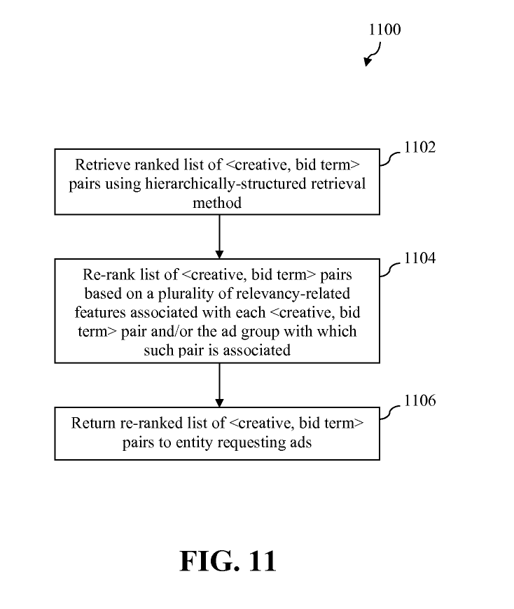

FIG. 11 depicts a flowchart 1100 of the re-ranking method. As shown in FIG. 11, the method of flowchart 1100 begins at step 1102 in which a ranked list of <creative, bid term> pairs is retrieved using a hierarchically-structured retrieval method. The hierarchically-structured retrieval method may comprise, for example, AdGrpRank or CrtvRank as described in the previous section.

At step 1104, the ranked list of <creative, bid term> pairs is re-ranked based on a plurality of relevancy-related features associated with each <creative, bid term> pair and/or the ad group with which such pair is associated. Such re-ranking may comprise, for example, calculating a relevancy score for each retrieved <creative, bid term> pair that is a linear combination of weighted relevancy-related features associated with each <creative, bid term> pair and/or the ad group with which such pair is associated. The linear combination may be that defined in Equation 4 above. As will be discussed below, the weights applied to each feature may be optimized. For example, the weights applied to each feature may be optimized by employing a learning to rank algorithm.

At step 1106, the re-ranked list of <creative, bid term> pairs is provided to an entity requesting ads.

The re-ranking procedure outlined above is referred to herein as StructRank. A pseudocode representation showing the application of the procedure to the AdGrpRank retrieval method is shown below as Algorithm 4.

Algorithm 4 StructRank (AdGrpInd index)

1: < g, c, t >← AdGrpRank
2: SORT DESC < g, c, t > BY rSc_{q} (g, c, t)
3: return < g, c, t >

The choice of features used in StructRank will play a crucial role in the resulting algorithm performance. Limiting the choice of features to field scores alone yields the mixture model in Equation 3. Since this model does not succeed in outperforming the baseline method that uses no structural information (CTRank), the set of features used by StructRank may be expanded to address certain issues specific to sponsored search that were described above. Using this expanded set of features will result in substantial performance improvements on a number of tasks.

Example features that may be used by StructRank as well as example methods that may be used for parameter optimization will now be described, although other features and methods not described herein may be used. The example features described below have the form f(g,c,t), and are therefore defined over a <c, t> pair and an ad group associated with it. The example features are as follows.

crtvTermPairScore is the score of the given <creative, bid term> pair. It is the equivalent to the sc_{q}(u_{c,t}) component in the mixture model in Equation 3.

adGrpScore is the score of the entire ad group, from which the <creative, bid term> pair was selected. It is equivalent to the sc_{q}(g) component in the mixture model in Equation 3.

adGrpTermCount is the number of term fields in a given ad group. As previously mentioned, a number of bid terms associated with an ad group can vary significantly. Since document length can affect the document's prior probability of retrieval, the number of bid terms can be explicitly added as a feature to the model.

adGrpEntropy is the entropy of an ad group. The entropy is computed over the individual words of the ad group as—Σ_{wεg} p_{g}(w) log p_{g}(w), where the probability of word wᵢ is computed using a maximum likelihood estimate

$${p}_{g} ( {w}_{i} ) = \frac{{tf}_{{w}_{i} , g}}{{\sum }_{{w}_{j ∈ g}} {tf}_{{w}_{j} , g}} .$$

Following previous work, where entropy was found related to document heterogeneity, entropy is used as an estimate of ad group cohesiveness—ad groups with smaller entropy will tend to be more cohesive.

adGrpQueryCover produces a real number r ε[0,1], such that r is the ratio of query words “covered” by any field in the ad group. It is common, especially for longer queries, that not all query terms will appear in the selected creative and term pair. The adGrpQueryCover feature helps differentiate between the ad groups that achieve high relevance scores due to a disproportional repetition of a single query word (bid term spamming) and those that achieve high relevance scores due to a more comprehensive coverage of query words.

AdGrp[Field]Ratio is the fraction of fields of type [Field] in an ad group that match at least one query word. Intuitively, one expects that ad groups that have high field match ratios with respect to a query, will yield more relevant <creative, bid term> pairs, since those ad groups will tend to be more focused on the query topic. [Field] denotes either one of the sub-fields of the creative field, or the entire bid term field. This produces three features based on the location of the match: AdGrpURLRatio, AdGrpTitleRatio and AdGrpTermRatio.

Additional features other than those outlined above may also be used to implement the re-ranking method.

Various methods may be used for optimizing the free parameters in the ranking function in Equation 4. When the number of free parameters is small (as, for instance, is the case in Equation 3), it is possible to optimize the parameters using an exhaustive search over the parameter space. However, when more features are introduced, such an exhaustive search quickly becomes infeasible.

To address this problem, a large and growing body of literature on the learning to rank methods for information retrieval may be relied upon. Learning to rank methods allow effective parameter optimization for ranking functions with respect to various retrieval metrics, even when a number of free parameters is high.

In one embodiment, a simple yet effective learning to rank approach is employed that directly optimizes the retrieval metric of choice. For example, the retrieval metric may be an nDCG metric. It is easy to see that the ranking function of Equation 4 is linear with respect to λᵢ. Therefore, the coordinate ascent algorithm proposed by Metzler and Croft may be used (see D. Metzler and W. B. Croft, Linear Feature-based Models for Information Retrieval, Information Retrieval, 10(3):257-274, 2007). This algorithm iteratively optimizes a multivariate objective function (such as, for example, rSc_{q} (g,c,t) of Equation 4) by performing a series of one-dimensional line searches. It repeatedly cycles through each parameter λᵢ, holding all other parameters fixed while optimizing λᵢ. This process is performed iteratively over all parameters until the gain in the target metric is below a certain threshold.

Although the coordinate ascent algorithm may be used for its simplicity and efficiency, any other learning to rank approach that estimates the parameters for linear models can be used. Other possible learning to rank algorithms include ranking SVMs, SVM^{MAP} or RankNet.

Due to the linearity of the above-defined ranking function, query dependent features (e.g., query length) cannot be readily incorporated into StructRank, since they will have the same contribution across all documents associated with a query. While this can be addressed by using non-linear rankers, such rankers typically require more training data and are more prone to overfitting than linear models. As a middle ground between linear and non-linear approaches, an embodiment bins the queries, and trains a specific model for each bin. Any query-dependent feature (or combination thereof) can be used for query binning. In various experiments it was found that binning by query length is both conceptually simple and empirically effective for retrieval optimization.

### E. Example General Indexing and Retrieval Methods

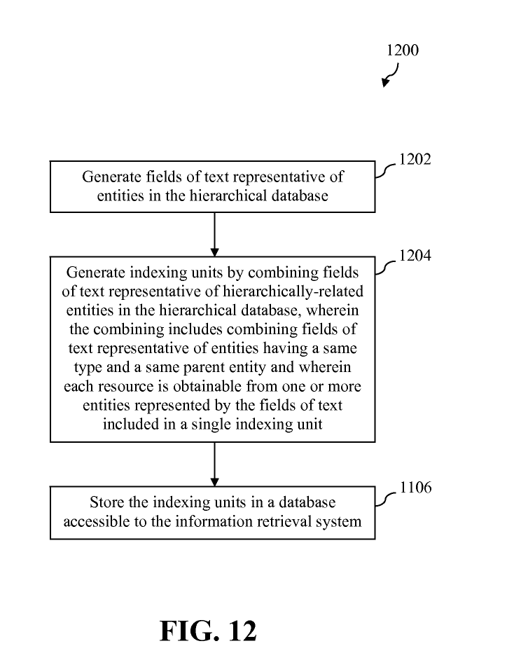

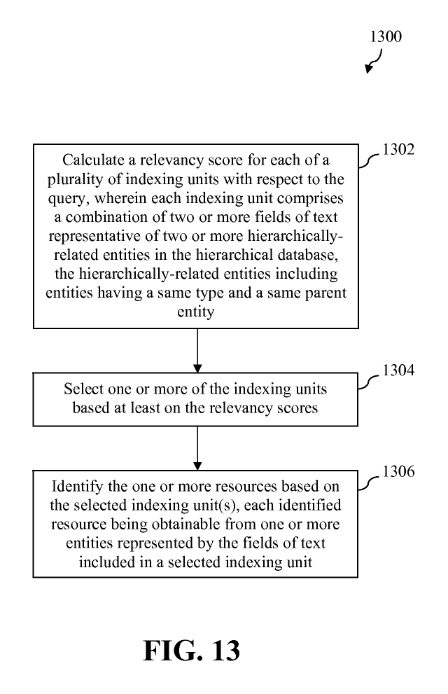

The indexing and retrieval methods described above in the context of an ad retrieval system can easily be extended to other information retrieval systems in which the retrievals are structured hierarchically. To help illustrate this, general methods for performing hierarchically-structured indexing and retrieval will now be described in reference to FIGS. 12 and 13.

In particular, FIG. 12 depicts a flowchart 1200 of a method for generating an index useable by an information retrieval system to identify resources stored in a hierarchical database in response to receiving a query. As shown in FIG. 12, the method of flowchart 1200 begins at step 1212 in which fields of text representative of entities in the hierarchical database are generated.

At step 1204, indexing units are generated by combining fields of text representative of hierarchically-related entities in the hierarchical database, wherein the combining includes combining fields of text representative of entities having a same type and a same parent entity and wherein each resource is obtainable from one or more entities represented by the fields of text included in a single indexing unit.

At step 1206, the indexing units are stored in a database accessible to the information retrieval system.

FIG. 13 depicts a flowchart 1300 of a method for identifying one or more resources from among a plurality of resources stored in a hierarchical database in response to receiving a query. As shown in FIG. 13, the method of flowchart 1300 begins at step 1302 in which a relevancy score is calculated for each of a plurality of indexing units with respect to the query, wherein each indexing unit comprises a combination of two or more fields of text representative of two or more hierarchically-related entities in the hierarchical database and wherein the hierarchically-related entities including entities having a same type and a same parent entity.

At step 1304, one or more of the indexing units are selected based at least on the relevancy scores.

At step 1306, the one or more resources are identified based on the selected indexing unit(s), wherein each identified resource is obtainable from one or more entities represented by the fields of text included in a selected indexing unit.

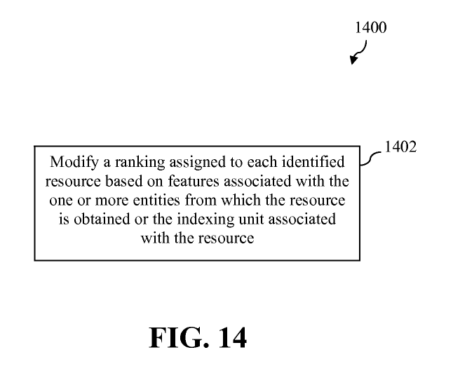

FIG. 14 depicts a flowchart 1400 of a re-ranking method that may be performed in conjunction with the hierarchically-structured retrieval method of FIG. 13. As shown in FIG. 14, flowchart 1400 includes a step 1402 that comprises modifying a ranking assigned to each identified resource based on features associated with the one or more entities from which the resource is obtained or the indexing unit associated with the resource.

### F. Example Processor-Based Implementations

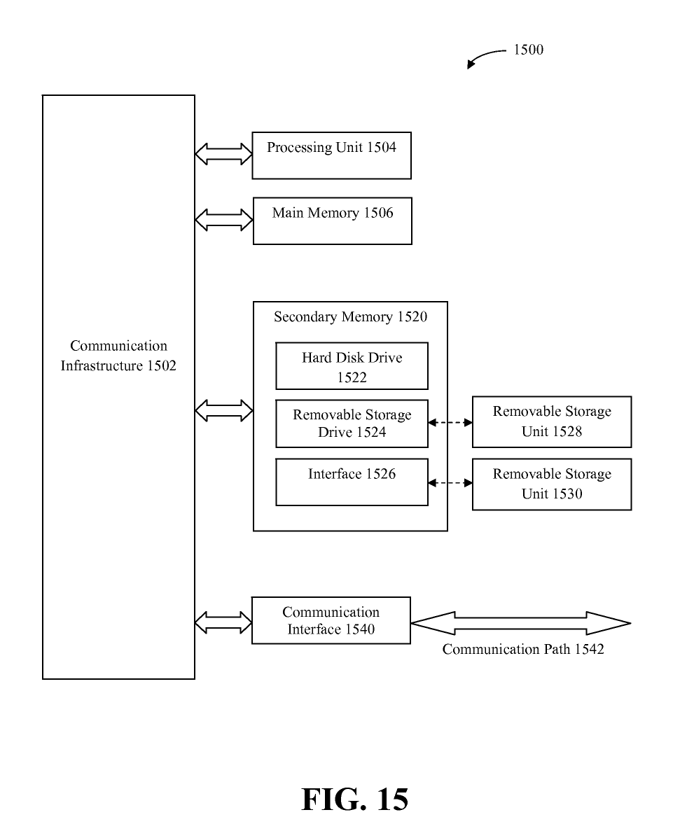

Any of the operational components of systems 100 or 200 as described above in reference to FIGS. 1 and 2, respectively, as well as any of the methods or steps described above with respect to flowcharts 400, 500, 600, 700, 800, 900, 1100, 1200, 1300 and 1400 as described above in reference FIGS. 4, 5, 6, 7, 8, 9, 11, 12, 13 and 14, respectively, may be implemented by one or more processor-based devices or systems. An example of such a system 1500 is depicted in FIG. 15.

As shown in FIG. 15, system 1500 includes a processing unit 1504 that includes one or more processors or processor cores. Processor unit 1504 is connected to a communication infrastructure 1502, which may comprise, for example, a bus or a network.

System 1500 also includes a main memory 1506, preferably random access memory (RAM), and may also include a secondary memory 1520. Secondary memory 1520 may include, for example, a hard disk drive 1522, a removable storage drive 1524, and/or a memory stick. Removable storage drive 1524 may comprise a floppy disk drive, a magnetic tape drive, an optical disk drive, a flash memory, or the like. Removable storage drive 1524 reads from and/or writes to a removable storage unit 1528 in a well-known manner. Removable storage unit 1528 may comprise a floppy disk, magnetic tape, optical disk, or the like, which is read by and written to by removable storage drive 1524. As will be appreciated by persons skilled in the relevant art(s), removable storage unit 1528 includes a computer usable storage medium having stored therein computer software and/or data.

In alternative implementations, secondary memory 1520 may include other similar means for allowing computer programs or other instructions to be loaded into system 1500. Such means may include, for example, a removable storage unit 1530 and an interface 1526. Examples of such means may include a program cartridge and cartridge interface (such as that found in video game devices), a removable memory chip (such as an EPROM, or PROM) and associated socket, and other removable storage units 1530 and interfaces 1526 which allow software and data to be transferred from removable storage unit 1530 to system 1500.

System 1500 may also include a communication interface 1540. Communication interface 1540 allows software and data to be transferred between system 1500 and external devices. Examples of communication interface 1540 may include a modem, a network interface (such as an Ethernet card), a communications port, a PCMCIA slot and card, or the like. Software and data transferred via communication interface 1540 are in the form of signals which may be electronic, electromagnetic, optical, or other signals capable of being received by communication interface 1540. These signals are provided to communication interface 1540 via a communication path 1542. Communications path 1542 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1528, removable storage unit 1530 and a hard disk installed in hard disk drive 1522. Computer program medium and computer readable medium can also refer to memories, such as main memory 1506 and secondary memory 1520, which can be semiconductor devices (e.g., DRAMs, etc.). These computer program products are means for providing software to system 1500.

Computer programs (also called computer control logic, programming logic, or logic) are stored in main memory 1506 and/or secondary memory 1520. Computer programs may also be received via communication interface 1540. Such computer programs, when executed, enable system 1500 to implement features of the present invention as discussed herein. Accordingly, such computer programs represent controllers of the computer system 1500. Where an aspect of the invention is implemented using software, the software may be stored in a computer program product and loaded into system 1500 using removable storage drive 1524, interface 1526, or communication interface 1540.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computer-implemented method for generating an index useable by an information retrieval system to identify resources stored in a hierarchical database in response to receiving a query, the method comprising:
generating fields of text representative of entities in the hierarchical database;
generating indexing units by combining fields of text representative of hierarchically-related entities in the hierarchical database, wherein the combining includes combining fields of text representative of entities having a same type and a same parent entity and wherein each resource is obtainable from one or more entities represented by the fields of text included in a single indexing unit; and
storing the indexing units in a database accessible to the information retrieval system.

2. The method of claim 1 wherein each resource comprises an advertisement formed from a creative and a bid phrase selectable from one or more creatives and one or more bid phrases contained within an advertisement group, the advertisement group being selectable from among a plurality of advertisement groups contained within the hierarchical database; and
wherein generating the fields of text representative of the entities in the hierarchical database comprises generating fields of text representative of each creative and each bid phrase stored in the hierarchical database.

3. The method of claim 2, wherein generating an indexing unit comprises combining a field of text representative of a creative contained within an advertisement group with fields of text representative of all bid phrases contained within the same advertisement group.

4. The method of claim 2, wherein generating an indexing unit comprises combining fields of text representative of all of the creatives contained within an advertisement group with fields of text representative of all bid phrases contained within the same advertisement group.

5. A system, comprising:
a hierarchical database that stores resources; and
a resource indexer that generates fields of text representative of entities in the hierarchical database, generates indexing units by combining fields of text representative of hierarchically-related entities in the hierarchical database, and stores the indexing units in a database accessible to the information retrieval system, the database accessible to the information retrieval system being useable by the information retrieval system to identify resources stored in the hierarchical database in response to receiving a query;
wherein the resource indexer combines fields of text representative of hierarchically-related entities to generate indexing units by combining fields of text representative of entities having a same type and a same parent entity; and
wherein each resource is obtainable from one or more entities represented by the fields of text included in a single indexing unit.

6. The system of claim 5, wherein each resource comprises an advertisement formed from a creative and a bid phrase selectable from one or more creatives and one or more bid phrases contained within an advertisement group, the advertisement group being selectable from among a plurality of advertisement groups contained within the hierarchical database; and
wherein the resource indexer generates the fields of text representative of the entities in the hierarchical database by generating fields of text representative of each creative and each bid phrase stored in the hierarchical database.

7. The system of claim 6, wherein the resource indexer generates an indexing unit by combining a field of text representative of a creative contained within an advertisement group with fields of text representative of all bid phrases contained within the same advertisement group.

8. The system of claim 6, wherein the resource indexer generates an indexing unit by combining fields of text representative of all of the creatives contained within an advertisement group with fields of text representative of all bid phrases contained within the same advertisement group.

9. A computer-implemented method for identifying one or more resources from among a plurality of resources stored in a hierarchical database in response to receiving a query, comprising:
calculating a relevancy score for each of a plurality of indexing units with respect to the query, wherein each indexing unit comprises a combination of two or more fields of text representative of two or more hierarchically-related entities in the hierarchical database, the hierarchically-related entities including entities having a same type and a same parent entity;
selecting one or more of the indexing units based at least on the relevancy scores; and
identifying the one or more resources based on the selected indexing unit(s), each identified resource being obtainable from one or more entities represented by the fields of text included in a selected indexing unit.

10. The method of claim 9, wherein the hierarchical database stores a plurality of advertisement groups and one or more creatives and one or more bid phrases within each advertisement group,
wherein each indexing unit comprises a combination of a field of text representative of a creative stored within an advertisement group and fields of text representative of all bid phrases stored within the same advertisement group, and
wherein identifying a resource comprises identifying a creative and bid phrase pair by identifying a creative represented by a selected indexing unit, calculating a relevancy score for each bid phrase represented by the selected indexing unit with respect to the query, and identifying the bid phrase having the highest relevancy score.

11. The method of claim 10, wherein identifying the resource further comprises filtering identified creatives so that only a single creative and bid phrase pair stored within each advertisement group will be included among the identified resources.

12. The method of claim 9, wherein the hierarchical database stores a plurality of advertisement groups and one or more creatives and one or more bid phrases within each advertisement group,
wherein each indexing unit comprises a combination of fields of text representative of all creatives stored within an advertisement group and fields of text representative of all bid phrases stored within the same advertisement group, and
wherein identifying a resource comprises identifying a identifying a creative and bid phrase pair by identifying an advertisement group represented by a selected indexing unit, calculating a relevancy score for each creative represented by the selected indexing unit with respect to the query, identifying the creative having the highest relevancy score, calculating a relevancy score for each bid phrase represented by the selected indexing unit with respect to the query, and identifying the bid phrase having the highest relevancy score.

13. The method of claim 9, further comprising:
modifying a ranking assigned to each identified resource based on features associated with the one or more entities from which the resource is obtained or the indexing unit associated with the resource.

14. The method of clam 13, wherein modifying the ranking assigned to each identified resource comprises modifying a ranking assigned to a creative and bid phrase pair based on features associated with the creative and bid phrase pair or an advertisement group with which the creative and bid phrase pair is associated.

15. The method of claim 14, wherein modifying the ranking assigned to the creative and bid phrase pair based on features associated with the creative and bid phrase pair or an advertisement group with which the creative and bid phrase pair is associated comprises modifying the ranking assigned to the creative and bid phrase pair based on one or more of:
a relevancy score calculated for the identified creative and bid phrase pair with respect to the query;
a relevancy score calculated for the advertisement group with respect to the query;
a number of term fields in the advertisement group;
a measure of entropy of the advertisement group;
a ratio of query words covered by any field in the advertisement group;
a fraction of URL sub-fields within any fields of text representative of creatives in the advertisement group that match at least one query word;
a fraction of title sub-fields within any fields of text representative of creatives in the advertisement group that match at least one query word; and
a fraction of terms within any fields of text representative of bid phrases in the advertisement group that match at least one query word.

16. A system for identifying one or more resources from among a plurality of resources stored in a hierarchical database, comprising:
a resource index that stores a plurality of indexing units, wherein each indexing unit comprises a combination of two or more fields of text representative of two or more hierarchically-related entities in hierarchical database, the hierarchically-related entities including entities having a same type and a same parent entity;
a resource retriever that receives a query and, responsive to receiving the query, calculates a relevancy score for each of the indexing units with respect to the query, selects one or more of the indexing units based at least on the relevancy scores, and identifies the one or more resources based on the selected indexing unit(s), each identified resource being obtainable from one or more entities represented by the fields of text included in a selected indexing unit.

17. The system of claim 16, wherein the hierarchical database stores a plurality of advertisement groups and one or more creatives and one or more bid phrases within each advertisement group,
wherein each indexing unit comprises a combination of a field of text representative of a creative stored within an advertisement group and fields of text representative of all bid phrases stored within the same advertisement group, and
wherein the resource retriever identifies a resource by identifying a creative and bid phrase pair, the identification of the creative and bid phrase pair comprising the steps of identifying a creative represented by a selected indexing unit, calculating a relevancy score for each bid phrase represented by the selected indexing unit with respect to the query, and identifying the bid phrase having the highest relevancy score.

18. The system of claim 17, wherein the resource retriever identifies the creative and bid phrase pair by filtering identified creatives so that only a single creative and bid phrase pair stored within each advertisement group will be included among the identified resources.

19. The system of claim 16, wherein the hierarchical database stores a plurality of advertisement groups and one or more creatives and one or more bid phrases within each advertisement group,
wherein each indexing unit comprises a combination of fields of text representative of all creatives stored within an advertisement group and fields of text representative of all bid phrases stored within the same advertisement group, and
wherein the resource retriever identifies a resource by identifying a creative and bid phrase pair, the identification of the creative and bid phrase pair comprising the steps of identifying an advertisement group represented by a selected indexing unit, calculating a relevancy score for each creative represented by the selected indexing unit with respect to the query, identifying the creative having the highest relevancy score, calculating a relevancy score for each bid phrase represented by the selected indexing unit with respect to the query, and identifying the bid phrase having the highest relevancy score.

20. The system of claim 16, wherein the resource retriever modifies a ranking assigned to each identified resource based on features associated with the one or more entities from which the resource is obtained or the indexing unit associated with the resource.

21. The system of claim 20, wherein the resource retriever modifies the ranking assigned to each identified resource by modifying a ranking assigned to a creative and bid phrase pair based on features associated with the creative and bid phrase pair or an advertisement group with which the creative and bid phrase pair is associated.

22. The system of claim 21, wherein the features associated with the creative and bid phrase pair or an advertisement group with which the creative and bid phrase pair is associated comprise one or more of:
a relevancy score calculated for the creative and bid phrase pair with respect to the query;
a relevancy score calculated for the advertisement group with respect to the query;
a number of term fields in the advertisement group;
a measure of entropy of the advertisement group;
a ratio of query words covered by any field in the advertisement group;
a fraction of URL sub-fields within any fields of text representative of creatives in the advertisement group that match at least one query word;
a fraction of title sub-fields within any fields of text representative of creatives in the advertisement group that match at least one query word; and
a fraction of terms within any fields of text representative of bid phrases in the advertisement group that match at least one query word.
